(19) United States
(12) Patent Application Publication
(10) Pub. No.: US 2024/0227907 A1
(43) Pub. Date: Jul. 11, 2024

(54) EXTENSION DEVICE, SEAT SYSTEM AND CART

(71) Applicant: CH BABY CO., LTD, Shaoxing (CN)

(72) Inventor: Congquan Ma, Shaoxing (CN)

(21) Appl. No.: 18/619,107

(22) Filed: Mar. 27, 2024

Related U.S. Application Data
(63) Continuation-in-part of application No. 17/549,787, filed on Dec. 13, 2021, now Pat. No. 11,981,364.

(51) Int. Cl. B62B 7/14; B62B 7/08

(52) U.S. Cl. CPC B62B 7/14; B62B 7/08

(57) ABSTRACT

An extension device, a seat system and a cart are disclosed. The extension device includes a frame that is detachably connected with the cart frame. The frame generally has an annular structure and consists of two rods, the frame has a length direction and a width direction, each rod has a transverse section extending in the width direction and extension sections connected to two ends of the transverse section respectively, and extension sections of the two rods corresponding in position are connected to each other. By improving the structure of the extension device, the compatibility between the seat and the cart frame is improved.

### CROSS-REFERENCE TO RELATED APPLICATIONS

The present application is a Continuation-in-Part Application of U.S. patent application Ser. No. 17/549,787, filed on Dec. 13, 2021, which is a Continuation Application of PCT/CN2020/091834, filed on May 22, 2020, which claims the priorities of Chinese Patent Application No. 201910516127.1, filed on Jun. 14, 2019, Chinese Patent Application No. 201920901673.2, filed on Jun. 14, 2019, Chinese Patent Application No. 201920897247.6, filed on Jun. 14, 2019, Chinese Patent Application No. 201920896383.3, filed on Jun. 14, 2019, and Chinese Patent Application No. 201920901075.5, filed on Jun. 14, 2019, the entire contents of which are hereby incorporated by reference.

### TECHNICAL FIELD

The present disclosure relates to the field of transportation tools, and in particular to an extension device, a seat system and a cart.

### DESCRIPTION OF THE PRIOR ART

A cart usually includes a cart frame and a seat assembly arranged on the cart frame. For daily portability and replacement, existing seat assemblies are often detachable. However, different types of seats and cart frames are not compatible, and the compatibility between the two needs to be further improved.

### SUMMARY OF THE DISCLOSURE

In order to solve the above problems, the present disclosure provides an extension device for cooperating with the cart frame of the cart. The extension device includes a frame that is detachably connected to the cart frame.

The frame generally has an annular structure and consists of two rods. The frame has a length direction and a width direction. Each rod has a transverse section extending in the width direction and extension sections connected to two ends of the transverse section respectively, and extension sections of the two rods corresponding in position are connected to each other.

Several alternatives are provided below, but they are not used as additional limitations on the above-mentioned solution, but only as further additions or preferences. Without technical or logical contradictions, the alternatives may be combined with the above-mentioned solution independently or in combination.

Optionally, each rod is a U-shaped rod, and the two U-shaped rods have openings opposite to each other in the length direction of the frame and form the annular structure.

Optionally, the two U-shaped rods are rotatably fit with each other through joints.

Optionally, the joint includes:
a first half shell fixed to one of the U-shaped rods, a first groove being defined inside the first half shell;
a second half shell fixed with the other U-shaped rod, the second half shell being rotatably connected to the first half shell and the first half shell and the second half shell being engaged with each other to form an installation chamber, and the second half shell having a second groove therein;
a locking member arranged in the installation chamber and slidable in a rotation axis of the first half shell, the locking member, when sliding in the rotation axis, having a locked state in which the locking member is engaged with the first and second grooves simultaneously, and an unlocked state in which the locking member is disengaged from one of the grooves;
a driving member having a spring structure and acting on the locking member to drive the locking member toward the locked state; and
an unlocking member movably installed in one of the half shells and acting on the locking member to drive the locking member toward the unlocked state.

Optionally, the locking member has a tooth for engaging with the first groove and the second groove, the tooth has two sides opposite to each other in a circumferential direction of the locking member, and wherein one side of the tooth is a slope for guiding the locking member to disengage from one of the grooves.

Optionally, each U-shaped rod has a transverse section extending in the width direction and extension sections connected to two ends of the transverse section respectively, and extension sections of the two U-shaped rods corresponding in position are connected to each other.

Optionally, extension sections of one of the U-shaped rods have bent portions so that the transverse section of said U-shaped rod sinks accordingly.

Optionally, the two U-shaped rods consist of a first rod and a second rod respectively, and the transverse section of the first rod is provided with an upper convex member.

Optionally, the bent portions are located on the extension sections of the first rod.

Optionally, the cart frame is provided with an extension seat, the extension device further includes an adapter fixed to the frame, and the adapter is configured to be plugged into the extension seat.

Two adapters are provided, which are respectively connected to the extension sections of the second rod, and each adapter is provided with one or more positioning structures.

Optionally, the transverse section of the second rod is provided with a limiting member, and the limiting member has one or more positioning structures.

The positioning structures on the adapter and the limiting member are configured to detachably connect a seat.

Optionally, the one or more positioning structures on the limiting member includes a mating hole, and the mating hole passes through the limiting member and is open to a bottom surface of the limiting member facing away from the first rod.

Optionally, the adapter includes:
a base portion fixed to the frame;
a plug portion located outside the base portion, wherein a top of the plug portion is fixedly connected with the base portion, and the plug portion extends downward for being inserted into the extension seat; and
an outer extension portion extending outward from the base portion in the width direction, wherein a top surface of the outer extension portion is provided with a receiving slot as the positioning structure.

Optionally, a lock hole is defined on an inside of the plug portion.

Optionally, a support member is provided on a bottom of the plug portion.

Optionally, the bottom of the plug portion has an upward recessed area, the support member is movably arranged in the recessed area, the plug portion has an inner cavity in which a spring member is provided, and one end of the support member is slidably inserted into the inner cavity and abuts against the spring member.

Optionally, the recessed area is provided with an avoidance hole communicated with the inner cavity, the support member extends into the inner cavity through the avoidance hole, and the support member is rod-shaped and has a radially outward protrusion located in the inner cavity to prevent the support member from falling off from the avoidance hole.

Optionally, the adapter further includes:
a plate-shaped portion extending downward from the base portion, wherein a bottom side of the plate-shaped portion has a positioning opening and/or a positioning hole as the positioning structure, and wherein a periphery of the positioning opening is open to the bottom side, and a periphery of the positioning hole is closed.

Optionally, the plate-shaped portion is located inside the plug portion.

Optionally, a pocket-shaped portion is provided below the positioning opening, and wherein a top side of the pocket-shaped portion is open, and an interior of the pocket-shaped portion is communicated with the positioning opening.

Optionally, the frame is further connected with a strap as a positioning structure.

The present disclosure further provides a seat system, including a seat and an extension device, and the extension device includes:
a frame which generally has an annular structure and consists of two rods, wherein the frame has a length direction and a width direction, each rod has a transverse section extending in the width direction and extension sections connected to two ends of the transverse section respectively, and extension sections of the two rods corresponding in position are connected to each other; and
an adapter fixed to the frame, wherein the adapter has a positioning structure, and the seat is detachably connected to the positioning structure.

The present disclosure further provides a cart, which includes a cart frame and a seat system. The seat system includes a seat and an extension device. The extension device includes:
a frame detachably connected to the cart frame, wherein the frame generally has an annular structure and consists of two rods, the frame has a length direction and a width direction, each rod has a transverse section extending in the width direction and extension sections connected to two ends of the transverse section respectively, and extension sections of the two rods corresponding in position are connected to each other; and
an adapter fixed to the frame, wherein the adapter has a positioning structure, and the seat is detachably connected to the positioning structure.

Optionally, the cart frame includes two side frames arranged opposite to each other; and a plurality of support members connected between the two side frames, and wherein each side frame includes a vertical synchronization rod with a front foot assembly and a rear foot assembly arranged on two sides of the vertical synchronization rod; the front foot assembly includes a front foot rod with an upper front oscillating rod and a lower front oscillating rod hinged between the vertical synchronization rod and the front foot rod; a bottom of the front foot rod is hinged to a front wheel; the rear foot assembly includes a rear foot rod with an upper rear oscillating rod and a lower rear oscillating rod hinged between the vertical synchronization rod and the rear foot rod; a bottom of the rear foot rod is hinged to a rear wheel.

In the folded state, the front foot assembly and the rear foot assembly respectively move towards the vertical synchronization rod, and in the deployed state, the front foot assembly and the rear foot assembly are correspondingly deployed.

The present disclosure discloses an extension device, a seat system and a cart. By improving the structure of the extension device, the compatibility between the seat and the cart frame is improved.

### BRIEF DESCRIPTION OF DRAWINGS

FIG. 1 is a schematic view of a cart according to an embodiment of the present disclosure;

FIG. 2 is a schematic view of the cart frame in FIG. 1 in a deployed state;

FIG. 3 is a schematic view of the cart frame in FIG. 2 during the folding process;

FIG. 4 is a schematic view of the cart frame in a folded state;

FIG. 5 is a partial view of a cart according to another embodiment of the present disclosure;

FIG. 6 is a schematic view of an extension device;

FIG. 7 is an exploded view of a joint;

FIG. 8 is an exploded view of the first half shell and the locking member in FIG. 7;

FIG. 9 is a cross-sectional view of the joint;

FIG. 10 is a schematic view of the extension device from another perspective;

FIG. 11 is a schematic view of an adapter;

FIG. 12a is a schematic view of the adapter with the plate-shaped portion not shown;

FIG. 12b is a cross-sectional view of a plug portion;

FIG. 13 is a schematic view of the cart frame installed with an extension seat and the extension device;

FIG. 14 is a schematic view of the extension seat installed on a support rod;

FIG. 15 is an enlarged view of part D in FIG. 13;

FIG. 16 is a cross-sectional view of the extension seat;

FIG. 17 is a partial view of the adapter;

FIG. 18 is a schematic view of the cart installed with a strap;

FIG. 19 shows the strap in FIG. 18 for fixation;

FIG. 20 is a schematic view of the cart with Velcro on the strap;

FIG. 21 shows the strap in FIG. 20 for fixation;

FIG. 22 is a schematic view of the seat having a first positioning member according to an embodiment;

FIG. 23 is a schematic view of the seat in FIG. 22 after being fixed;

FIG. 24 is a schematic view of the first positioning member engaging with the positioning opening in FIG. 23;

FIG. 25 is a schematic view of the seat having a second positioning member according to an embodiment;

FIG. 26 is a schematic view of the seat in FIG. 25 after being fixed;

FIG. 27 is a schematic view of the snap opening engaging with the transverse section in FIG. 26;

FIG. 28 is a schematic view of the second positioning member engaging with the positioning hole in FIG. 26;

FIG. 29 is a schematic view of the seat engaging with the extension device according to an embodiment; and

FIG. 30 is a schematic view of the extension section engaging with the limiting member in FIG. 29.

### LIST OF REFERENCE SIGNS

1, cart frame; 10, side frame; 11, front foot assembly; 111, front foot rod; 112, upper front oscillating rod; 113, lower front oscillating rod; 12, rear foot assembly; 121, rear foot rod; 122, upper rear oscillating rod; 123, lower rear oscillating rod; 124, rear wheel; 13, vertical synchronization rod; 14, first connection member; 15, second connection member;
3, locking mechanism;
4, seat; 41, first positioning member; 42, second positioning member; 43, snap opening; 44, extension section;
5, extension seat; 51, first fastener; 52, second fastener; 53, mating seat; 531, unlock button; 532, transverse bar; 533, locking portion; 534, return spring; 535, plug opening; 55, driving member; 56, support rod;
6, extension device;
60, frame; 61, first rod; 611, first half shell; 612, first groove; 613, unlocking member; 614, transverse section; 615, extension section; 616, upper convex member; 62, the second rod; 621, the second half shell; 622, the second groove; 623, the bent portion; 624, transverse section; 625, extension section; 626, transition portion; 63, installation chamber; 64, locking member; 641, tooth; 642, slope;
65, adapter; 66, adapter; 661, receiving slot; 662, base portion; 663, plug portion; 664, extension portion; 665, recessed area; 667, inner cavity; 668, avoidance hole; 669, plate-shaped portion; 670, positioning opening; 671, positioning hole; 672, lock hole; 673, support member; 674, radially outward protrusion; 675, pocket-shaped portion; 68, limiting member; 681, mating hole; 682, strap.

### DESCRIPTION OF EMBODIMENTS

The technical solutions in the embodiments of the present disclosure will be clearly and completely described below in conjunction with the accompanying drawings in the embodiments of the present disclosure. Apparently, the described embodiments are only a part of the embodiments of the present disclosure, rather than all the embodiments. Based on the embodiments in the present disclosure, all other embodiments obtained by those of ordinary skill in the art without creative work shall fall within the protection scope of the present disclosure.

It should be noted that when an assembly is referred to as being “connected” to another assembly, it can be directly connected to another assembly or an intermediate assembly may also exist. When one component is considered to be “provided” on another component, it can be directly provided on the other component or an intermediate component may be present at the same time.

Unless otherwise defined, all technical and scientific terms used herein are the same as meanings of general understandings of those skilled in the art of the disclosure. The terms used in the description of the present disclosure herein are merely to describe the specific embodiments, not intended to limit the present disclosure. The term “and/or” used herein includes any and all combinations of one or more related listed items.

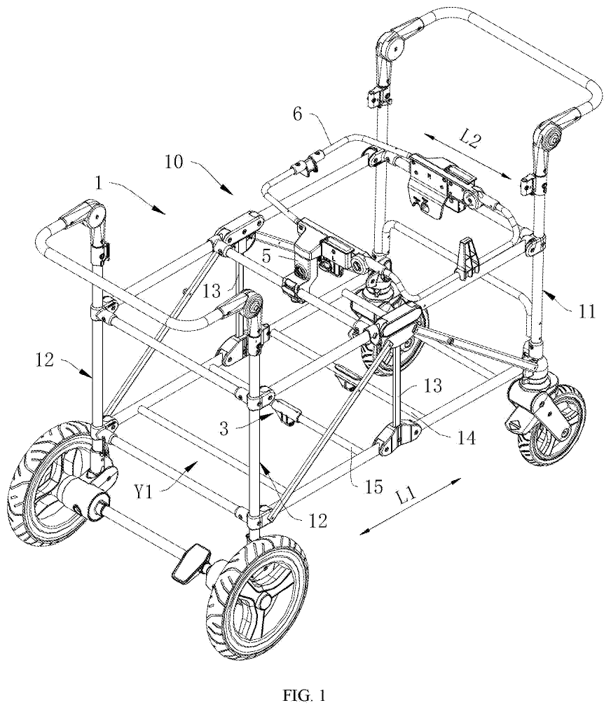

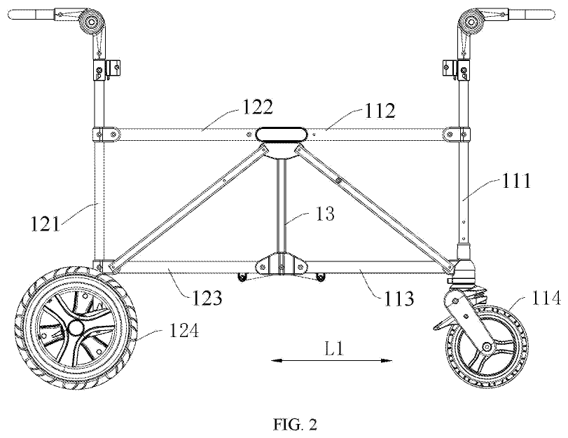

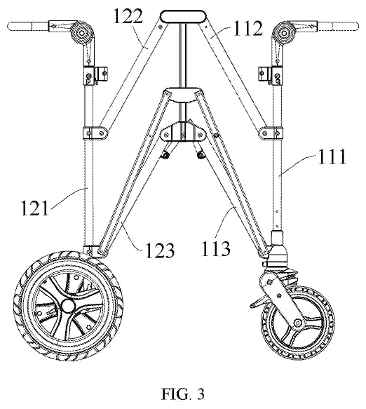

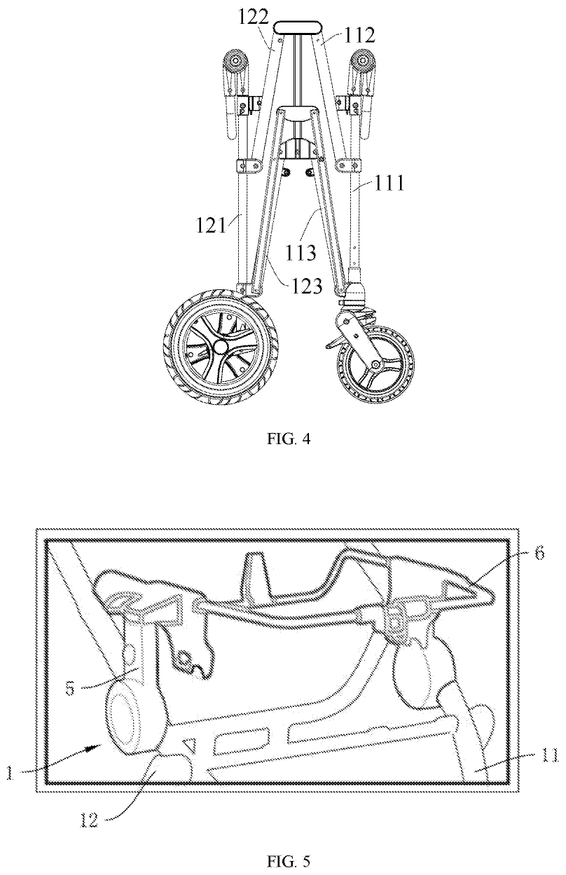

Referring to FIGS. 1 to 5, an embodiment of the present disclosure provides an extension device 6 for engaging with the cart frame 1 of the cart. The cart frame 1 has a front side and an opposing rear side, and the length direction L1 extends from the front side to the rear side (see FIGS. 1 and 2). Only for ease of description and understanding, the right side shown in FIG. 2 represents the front side, and the left side represents the rear side, which sides are not intended to limit the movement direction or user orientation in use.

In one embodiment, referring to FIGS. 1 to 4, the cart has a deployed state and a folded state. Unless otherwise specified in the present disclosure, the positional relationship and spatial attitude of the components of the cart are described referring to the deployed state. The Y1 perspective in FIG. 1 is the perspective of the cart frame 1 in the width direction, the other side in the width direction has the same or similar structure, and the corresponding components on the two sides can be connected by connectors (such as rods or brackets, etc.), to ensure strength, as well as to define an accommodation space.

The cart frame 1 includes two side frames 10 arranged side by side, and a plurality of support members connected between the two side frames 10. Each side frame 10 includes a vertical synchronization rod 13 and a front foot assembly 11 and a rear foot assembly 12 which are distributed on two sides of the vertical synchronization rod 13 respectively. In the folded state, the front foot assembly 11 and the rear foot assembly 12 respectively move towards the vertical synchronization rod 13. In the deployed state, the front foot assembly 11 and the rear foot assembly 12 are correspondingly unfolded. The support members include a first connection member 14 connected between the front foot assemblies 11 of the two side frames 10, and a second connection member 15 connected between the rear foot assemblies 12 of the two side frames 10. A locking mechanism 3 for limiting a relative position between the first connection member 14 and the second connection member 15 to keep the deployed state is provided between the first connection member 14 and the second connection member 15. The locking mechanism 3 further has an unlocked state for allowing the first connection member 14 and the second connection member 15 to move towards each other. For the convenience of description below, this cart frame 1 structure is referred to as A.

In the deployed state of the cart, the plurality of support members between the two side frames 10 keep the stability between the two side frames 10, and the deployed state of the single side frame 10 is maintained through the locking mechanism 3. Since the locking mechanism 3 is arranged on the first connection member 14 and the second connection member 15, the states of the two side frames 10 can be kept synchronous, thus realizing deploying or folding of the entire cart. In order to achieve the folding and deploying of the cart, the front foot assembly 11 and the rear foot assembly 12 may be connected to the vertical synchronization rod 13 through a deformable rod structure respectively. When the locking mechanism 3 works, the relative position relationship between the first connection member 14 and the second connection member 15 is fixed, and the deformable rod structures of the front foot assembly 11 and the rear foot assembly 12 cannot deform, thus achieving a stable spatial structure of the cart.

Therefore, the deformable rod structures of the front foot assembly 11 and the rear foot assembly 12 define different spatial structures of the cart in the folded state and the deployed state. Referring to FIGS. 1-4, in one embodiment, the front foot assembly 11 includes a front foot rod 111, and an upper front oscillating rod 112 and a lower front oscillating rod 113 which are hinged between the vertical synchronization rod 13 and the front foot rod 111. The bottom of the front foot rod 111 is hinged with a front wheel 114. The rear foot assembly 12 includes a rear foot rod 121, and an upper rear oscillating rod 122 and a lower rear oscillating rod 123 which are hinged between the vertical synchronization rod 13 and the rear foot rod 121. The bottom of the rear foot rod 121 is hinged with a rear wheel 124. The front foot assembly 11 (i.e., the front foot rod 111, the upper front oscillating rod 112, and the lower front oscillating rod 113) and the vertical synchronization rod 13 forms a deformable four-bar linkage. The four-bar linkage can be configured as a planar mechanism or a three-dimensional mechanism in space. In the deploying process of the cart, the four-bar linkage can deform so that the front foot assembly 11 moves away from the vertical synchronization rod 13. In the folding process of the cart, the four-bar linkage can deform so that the front foot assembly 11 moves towards the vertical synchronization rod 13. Therefore, the four-bar linkage constitutes a basic unit for changing the spatial attitude of the cart. The rear foot assembly 12 has the same structure as the front foot assembly 11, which will not be repeated here.

In another embodiment, referring to FIG. 5, the cart frame 1 includes a front foot assembly 11 and a rear foot assembly 12. The front foot assembly 11 and the rear foot assembly 12 are obliquely arranged. The top is rotatably connected, and the bottom is provided with a wheel (not shown in the figure). An extension device 6 can be provided above the connection between the front foot assembly 11 and the rear foot assembly 12. For the convenience of description, this cart frame 1 structure is referred to as B.

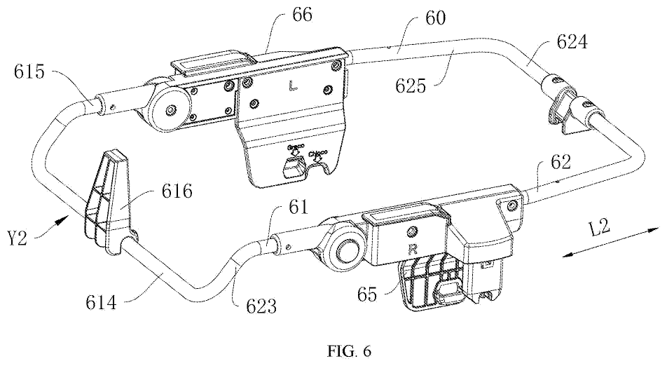

Referring to FIG. 1, FIG. 5 and FIG. 6, the cart frame 1 is provided with an extension seat 5, and the extension device 6 includes:
a frame 60, which generally has an annular structure and is formed by two rods. The frame 60 has a length direction and a width direction. Refer to L2 in FIG. 1 and FIG. 6, where L1 and L2 are perpendicular to each other, and the Y2 perspective is the width direction of the frame 60. Each rod has a transverse section extending in the width direction and extension sections connected to two ends of the transverse section respectively. The corresponding extension sections of the two rods are connected to each other.

Referring to FIG. 6, each rod is U-shaped, that is, the frame 60 includes two U-shaped rods, namely the first rod 61 and the second rod 62. The first rod 61 has a transverse section 614 and extension sections 615. The second rod 62 has a transverse section 624 and extension sections 625. The extension section 615 and the corresponding extension section 625 are connected to each other. The two extension sections of the same U-shaped rod have the same length. In this embodiment, the length of the extension section 625 is greater than the length of the extension section 615.

For flexible application, the frame 60 is detachably connected to the cart frame 1. In one embodiment, the extension device 6 is further provided with an adapter. The adapter is fixed to the frame 60 and is configured to be plugged into the extension seat 5.

The inner side and the outer side described below here are relative terms. Taking the inner side and the outer side of the frame 60 as an example, the inner side is the side inside the frame 60 and the outer side is the side outside the frame 60, which are divided by the frame 60.

Here, an extension seat is provided on the cart frame 1 and the adapter can be plugged into the extension seat 5. In order to improve compatibility and achieve better adaptation, the two U-shaped rods are rotatably fit with each other by joints.

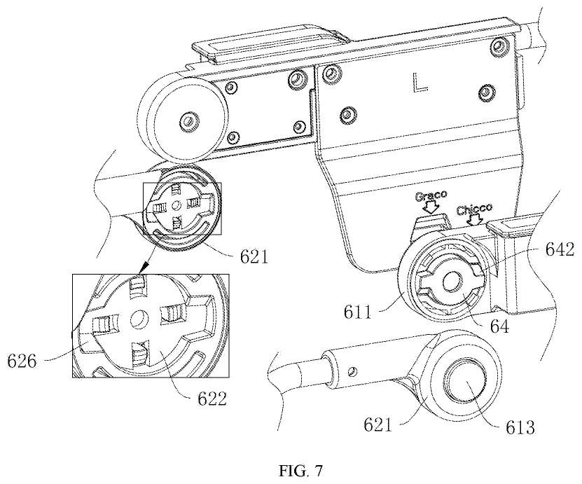

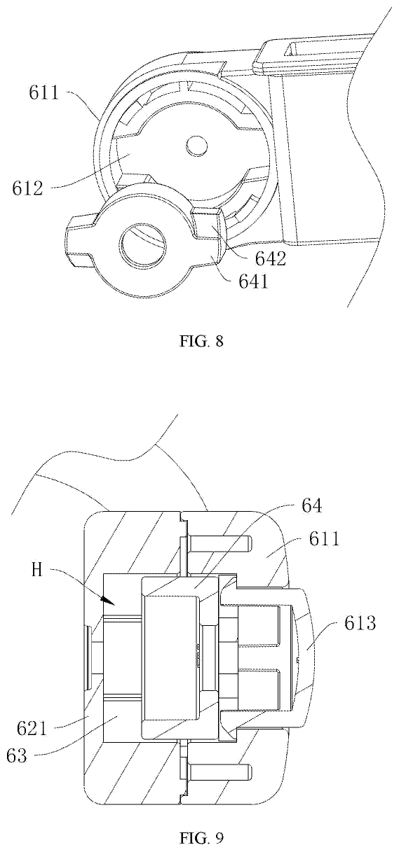

Referring to FIG. 7 to FIG. 9, the joint includes:
a first half shell 611 fixed to the second rod 62, a first groove 612 being defined inside the first half shell 611;
a second half shell 621 fixed to the first rod 61, the second half shell 621 being rotatably connected to the first half shell 611, the first half shell 611 and the second half shell 621 being engaged with each other to define an installation chamber 63, and the second half shell 621 having a second groove 622 therein;
a locking member 64 arranged in the installation chamber 63 and slidable in the rotation axis of the first half shell 611, the locking member 64, when sliding in the rotation axis, having a locked state in which the locking member 64 is engaged with the first and second grooves 612 and 622 simultaneously, and an unlocked state in which the locking member 64 is disengaged from one of the grooves;
a driving member (not shown in the figure, installed at the H position shown in FIG. 9) having a spring structure and acting on the locking member 64 to drive the locking member 64 toward the locked state; and
an unlocking member 613 movably installed in one of the half shells (here, in the second half shell 621 as shown in the figure) and acting on the locking member 64 to drive the locking member 64 toward the unlocked state. To unlock the joint, the unlocking member 613 is pressed, so that the locking member 64 presses the driving member to gradually approach the first groove 612 until it is completely separated from the second groove 622 and thus transforms into the unlocked state. Now, the second half shell 621 can be rotated relative to first half shell 611.

For the convenience of unlocking, the locking member 64 has teeth 641 for engaging with the first groove 612 and the second groove 622. The tooth 641 has two sides opposite to each other in the circumferential direction of the locking member 64, and one side is a slope 642 for guiding the locking member 64 to disengage from one of the grooves. As shown in FIGS. 6 to 8, a groove wall of the second groove 622 is tilted to match the slope 642. This groove wall serves as a transition portion 626 for disengaging the locking member 64 from the second groove 622. Therefore, even if the force of pressing the unlocking member 613 is relatively small so that the locking member 64 cannot be completely separated from the second groove 622, under the action of the transition portion 626 and the slope 642, when the second half shell 621 is rotated relative to the first half shell 611, the locking member 64 can gradually move away from the second groove 622 until it is completely disengaged from the second groove 622.

Further, referring to FIG. 6, the extension section 615 of the first rod 61 has a bent portion 623, the transverse section 614 of the first rod 61 sinks accordingly, and the transverse section 614 is provided with an upper convex member 616 located at the middle position of the transverse section 614. The extension device 6 can be used to install a seat 4, and the joints allow the transverse section 614 to turn downward to lower the height of the upper convex member 616 so as to avoid the seat.

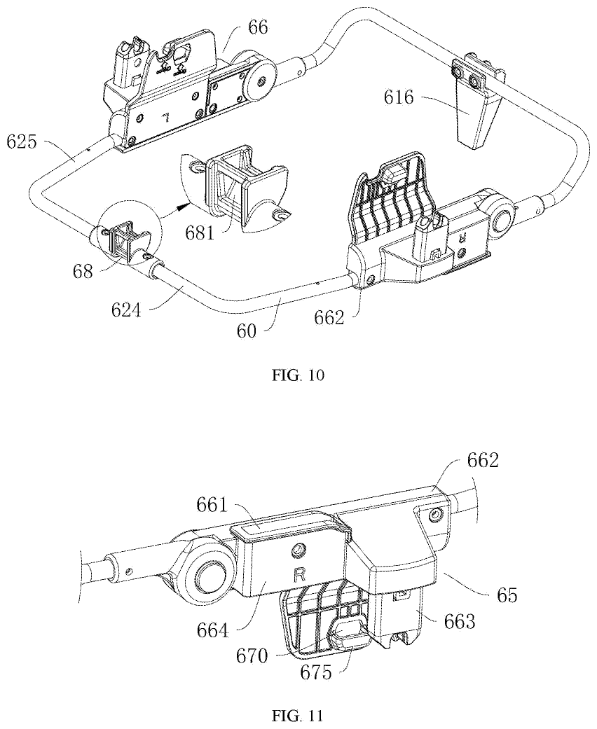

Referring to FIGS. 6 and 10, further, two adapters are provided, which are respectively connected to the extension sections 625 of the second rod 62. The two adapters are arranged opposite to each other, see the adapter 65 and the adapter 66 shown in the figure.

The transverse section 624 of the second rod 62 is fixed with a limiting member 68, and the limiting member 68 is preferably located at the middle position of the transverse section 624.

In order to improve compatibility with other accessories of different types or structures (such as the cart frame 1, seat, etc.), the adapters and limiting member 68 are each provided with one or more positioning structures.

The positioning structure on the limiting member 68 includes a mating hole 681 that passes through the limiting member 68 and is open to the bottom surface of the limiting member 68 facing away from the first rod.

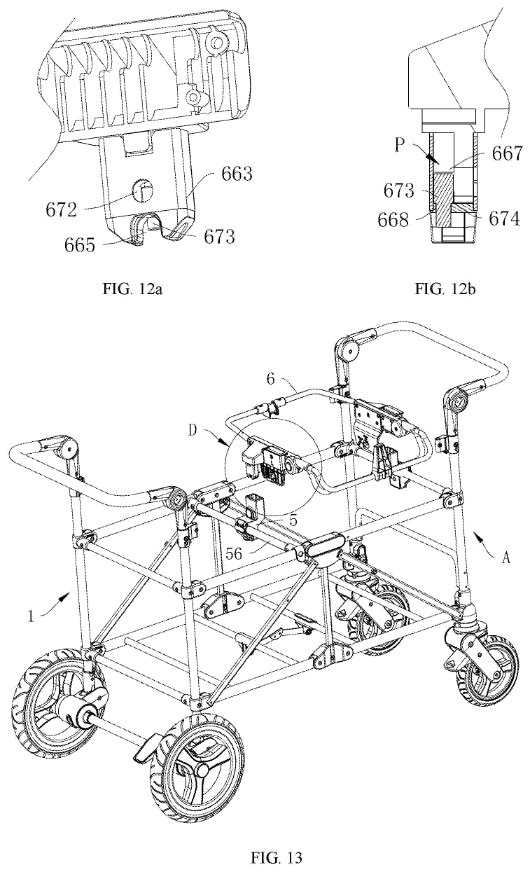

Refer to FIG. 11 to FIG. 12b, taking one of the adapters as an example (the other adapter has the same structure), it includes:
a base portion 662 fixed to the frame 60;
a plug portion 663 located outside the base portion 662, the top of the plug portion 663 being fixedly connected to the base portion 662 and the plug portion 663 extending downward to be inserted into the extension seat 5; and
an outer extension portion 664 extending outward from the base portion 662 in the width direction, and a receiving slot 661 as a positioning structure being defined on the top surface of the outer extension portion 664.

In order to facilitate unlocking, a lock hole 672 is defined on the inside of the plug portion 663, and a support member 673 is provided at the bottom. Specifically, the bottom of the plug portion 663 has an upward recessed area 665, and the support member 673 is movably provided in the recessed area 665. The plug portion 663 has an inner cavity 667, and a spring member (not shown in the figure, specifically installed at the P position) is provided in the inner cavity 667. One end of the support member 673 is slidably inserted into the inner cavity 667 and abuts against the spring member.

The recessed area 665 is provided with an avoidance hole 668 communicated with the inner cavity 667. The support member 673 extends into the inner cavity 667 through the avoidance hole 668. The support member 673 is rod-shaped and has a radially outward protrusion 674 located in the inner cavity 667 to prevent the support member 673 from falling off from the avoidance hole 668.

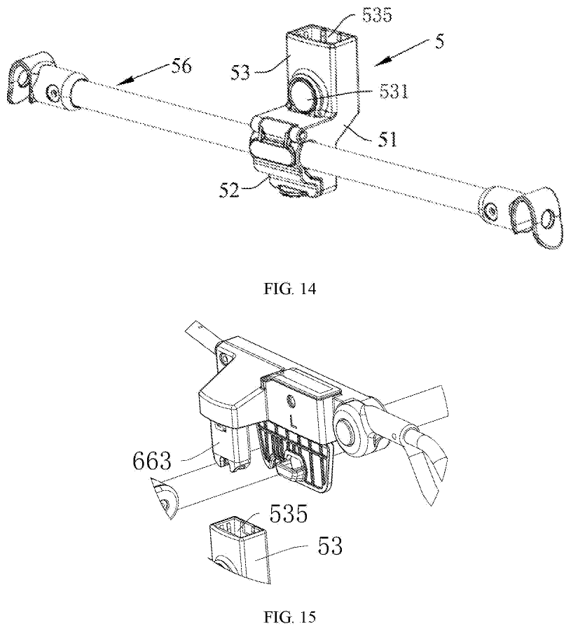

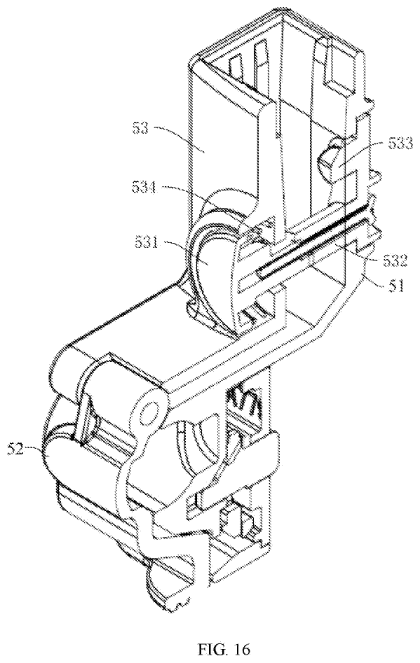

In the unlocked state, the support member 673 is exposed to the recessed area 665 under the action of the spring member. To understand how the plug portion 663 is locked and fixed with the extension base 5, the cart with the cart frame 1 structure A is taken as an example. Referring to FIG. 13 to FIG. 16, the cart frame 1 is provided with an extension seat 5 and one or more support rods 56. Each support rod 56 is detachably installed on the cart frame 1 or configured as a part of the cart frame 1. The extension seat 5 include:
a first fastener 51 attached to a peripheral surface of the support rod 56;
a second fastener 52, the first fastener 51 and second fastener 52 together surrounding the support rod 56; and
a mating seat 53 fixed on the first fastener 51, the mating seat 53 having a plug opening 535 for engaging with the extension device 6.

The extension device 6 is connected to the cart frame 1 through the extension seat 5, and the extension seat 5 is detachably connected to the cart frame 1, which will not affect the use of the cart and can meet the use demands for different scenarios.

In order to be lockable with the plug portion 663, the mating seat 53 has a locking structure therein. The locking structure includes an unlock button 531 provided on the outside of the mating seat 53, a transverse bar 532 passing through the mating seat 53, and a locking portion 533 that is synchronously movable with the transverse bar 532. The locking portion 533 protrudes toward the interior of the mating seat 53 and is arranged opposite to the unlock button 531. The transverse bar 532 and the unlock button 531 move synchronously. Preferably, the three (the unlock button 531, transverse bar 532 and locking portion 533) are formed in one piece. For automatic reset, a return spring 534 is provided between the unlock button 531 and the mating seat 53.

To connect the extension device 6 and the extension seat 5 fixedly, the plug portion 663 is inserted into the mating seat 53. During the insertion of the plug portion 663, it will first abut against the locking portion 533, and the locking portion 533 is presses to move outward, now the return spring 534 is compressed. And then the support member 673 abuts against the transverse bar 532 and thus retracts toward the inner cavity 667, now the spring member at the P position is gradually compressed until the lock hole 672 is aligned with the locking portion 533. Under the action of the return spring 534, the locking portion 533 enters the lock hole 672 so as to realize locking.

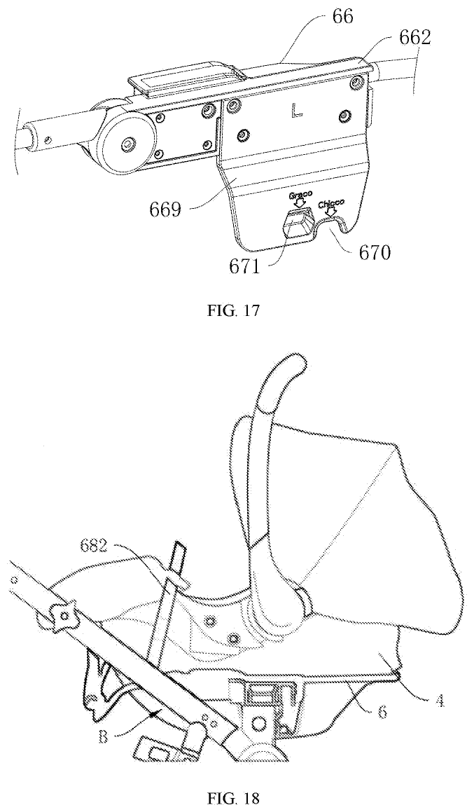

To realize unlocking, the unlock button 531 is pressed so that the locking portion 533 moves outward, and the support member 673 is unlocked. Under the action of the spring member at the P position, the support member 673 is exposed to the recessed area 665, and the lock hole 672 is misaligned with the locking portion 533 in the axial direction. Now the extension device 6 can be removed with an upward force. Referring to FIG. 11 and FIG. 17 to FIG. 18, the adapter further includes:
a plate-shaped portion 669 extending downward from the base portion 662. The bottom side of the plate-shaped portion 669 has a positioning opening 670 and/or a positioning hole 671 as a positioning structure. The periphery of the positioning opening 670 is open downward, and the periphery of the positioning hole 671 is closed. Preferably, the plate-shaped portion 669 is provided with a positioning opening 670 and a positioning hole 671. As shown in FIG. 17, the positioning hole 671 is located in the middle of the plate-shaped portion 669, the positioning opening 670 is located on the right side of the positioning hole 671, and the plate-shaped portion 669 is located inside the plug portion 663.

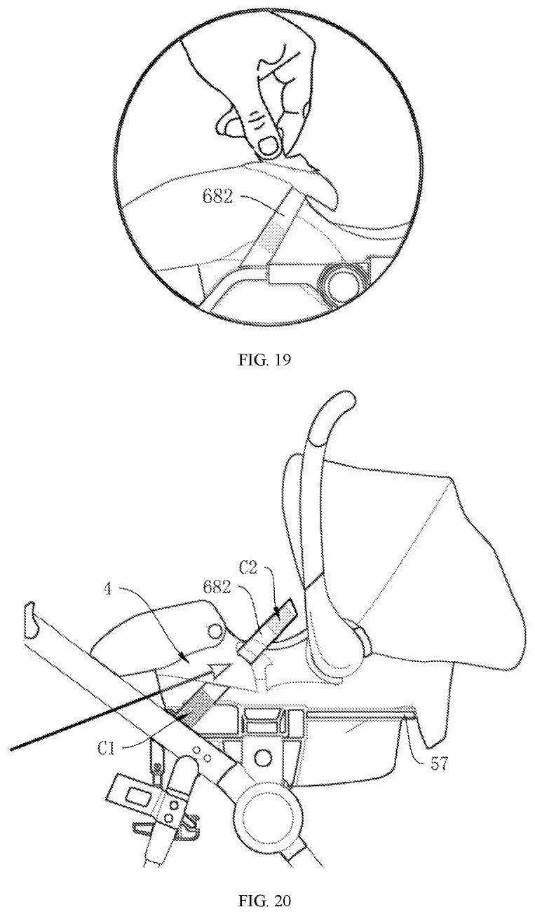

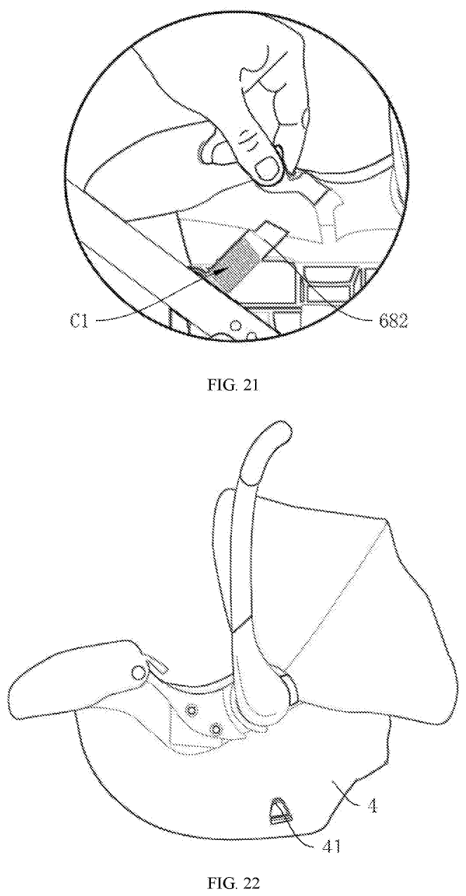

The outer side of the plate-shaped portion 669 is provided with a pocket-shaped portion 675 located below the positioning opening 670 (see FIG. 11). The top side of the pocket-shaped portion 675 is open, and the interior of the pocket-shaped portion 675 is communicated with the positioning opening 670. For further fixation, referring to FIGS. 18 to 21, the frame 60 is further connected with a strap(s) 682 as a positioning structure. In this embodiment, two straps 682 are provided which are installed on the extension sections 615 respectively and arranged opposite to each other. The straps 682 can be fixed in various ways, which are not specifically limited here, as long as the straps 682 can be fixed with other accessories, such as the seat 4. For example, the seat 4 is provided with locking structures (such as hooks or strap holes, etc.) to fix the straps 682 on two sides. In use, the user only needs to tighten and fix the straps 682 on two sides through the locking structures.

For another example, the strap 682 can be provided with Velcro C1 and C2 that can be attached to each other. In use, the user only needs to pass the strap 682 on the corresponding side through the seat 4 and align and attach the Velcro C1 and C2 together, thereby realizing fixation.

The present disclosure further discloses a seat system, which includes a seat 4 and an extension device 6. Depending on different demands, the seat 4 can be a sitting-type, lying-type, sitting-and-lying adjustable type, or basket-type seat, etc. The seat 4 here can be adaptively selected according to the actual practice. The extension device 6 can be the extension device 6 with the positioning structure mentioned above. The seat 4 and the positioning structure can be detachably connected together.

The positioning structure may the above-mentioned mating hole 681, receiving slot 661, positioning opening 670, positioning hole 671 and strap 682, one or more of which can be used to fixedly connect the seat 4 with the extension device 6 in practice.

For the convenience of description, the cart frame 1 structure B will be used as an example for explanation.

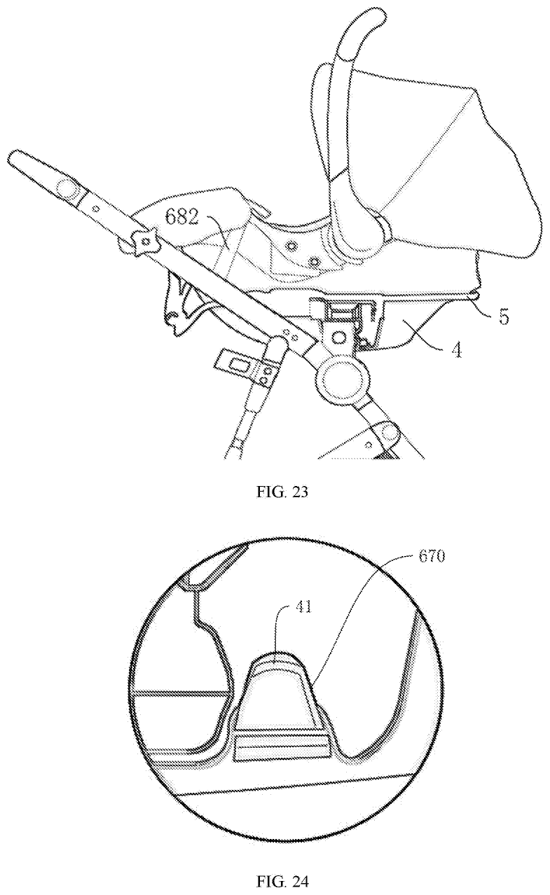

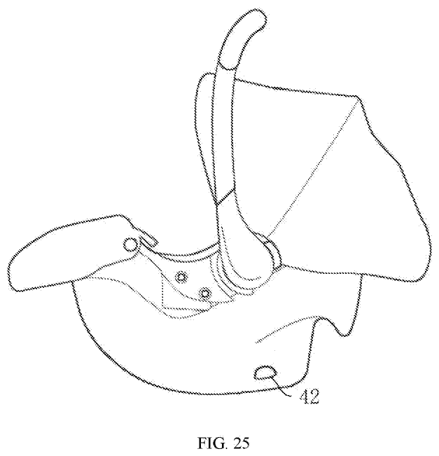

Referring to FIGS. 22 to 24, in one embodiment, the positioning structure consists of a positioning opening 670 and a strap 682. Specifically, the seat 4 is provided with a first positioning member 41, and the first positioning member 41 is a protrusion located on a side wall of the seat and matching the positioning opening 670. When assembling the seat 4 with the extension device 6, the first positioning member 41 is first engaged and fixed with the positioning opening 670, and then the strap 682 is used for fixation, thereby realizing installation.

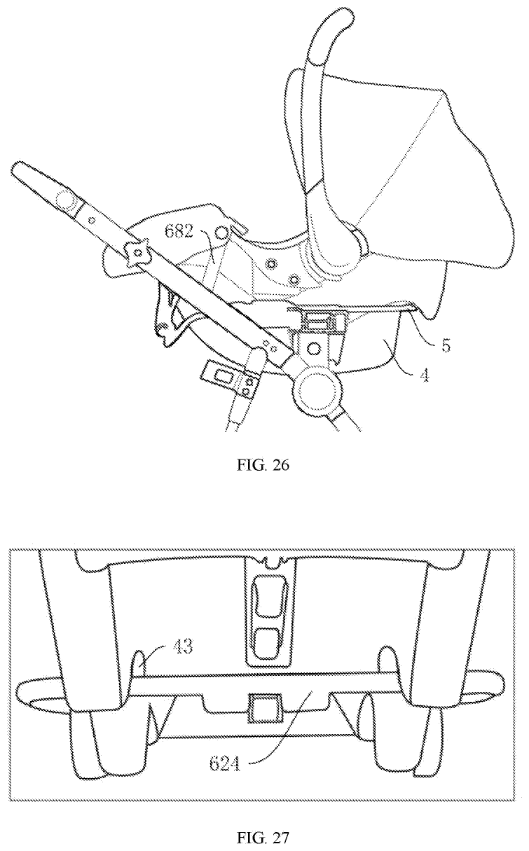

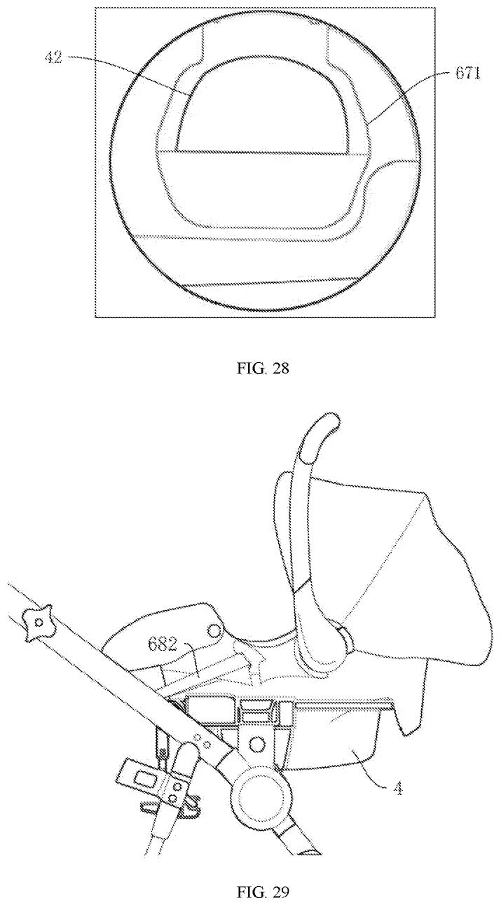

Referring to FIGS. 25 to 28, in another embodiment, the positioning structure consists of a positioning hole 671 and a strap 682. The seat 4 is provided with a snap opening 43 and a second positioning member 42 for cooperating with the positioning hole 671. The second positioning member 42 is a protrusion located on a side wall of the seat and matching the positioning hole 671 in shape. The snap opening 43 is formed by the right side of the seat 4 extending partially downward. When assembling the seat 4 with the extension device 6, the second positioning member 42 is first engaged and fixed with the positioning hole 671, and the transverse section 624 is also inserted into and abuts against the snap opening 43. Then, the strap 682 is used for fixation, thereby realizing installation.

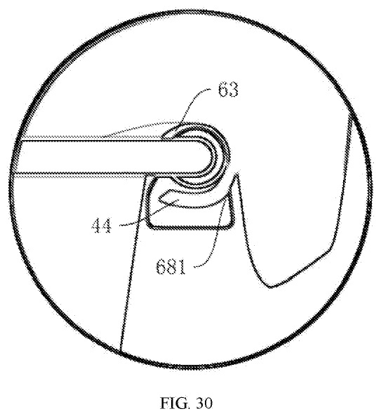

Referring to FIGS. 29 and 30, in another embodiment, the positioning structure consists of a mating hole 681 and a strap 682. The seat 4 has a snap opening 43, and is further provided with an extension section 44 (hook-shaped) for extending into the mating hole 681 and engaging with the transverse section 614. When assembling the seat 4 with the extension device 6, the extension section 44 extends into the side mating hole 681 in a snap fit, and then the strap 682 is used for fixation, thereby realizing installation.

The assembly of the above-mentioned cart frame 1 and the extension device 6 is not limited to the above-mentioned embodiments. For example, the positioning structure may consist of the receiving slot 661 and the strap 682, and the assembly can be implemented through this positioning structure accordingly, which will not be repeated here.

The present disclosure further provides a cart, which includes a cart frame 1 and a seat system. The cart frame 1 is provided with an extension seat 5. The cart frame 1 and the seat system can use the above configurations.

When assembling the cart frame 1, the extension device 6 and the seat 4, the extension base 5 of the cart frame 1 and the extension device 6 should be assembled and fixed together first (by engaging and fixing the mating seat 53 with the plug portion 663), and then the extension device 6 and the seat 4 are assembled together according to the method above.

The extension device 6 disclosed here can be used to assemble and fix different cart frames 1 and seats 4 together to form carts, thereby improving compatibility.

The technical features of the embodiments described above can be arbitrarily combined. In order to make the description concise, all possible combinations of various technical features in the above embodiments are not completely described. However, the combinations of these technical features should be considered as the scope described in this specification as long as there is no contradiction in them. When the technical features of different embodiments are reflected in the same accompanying drawing, it can be regarded as that the accompanying drawing, further discloses a combined example of all the embodiments involved.

The above-mentioned embodiments only express several implementation modes of the present disclosure, and their descriptions are more specific and detailed, but they cannot be understood as limiting the patent scope of the present disclosure. It should be noted that those of ordinary skill in the art can further make various transformations and improvements without departing from the concept of the disclosure, and these transformations and improvements all fall within the protection scope of the present disclosure.

1. An extension device for cooperating with a cart frame of a cart, comprising a frame detachably connected with the cart frame;
wherein the frame generally has an annular structure and consists of two rods, the frame has a length direction and a width direction, each rod has a transverse section extending in the width direction and extension sections connected to two ends of the transverse section respectively, and extension sections of the two rods corresponding in position are connected to each other.

2. The extension device of claim 1, wherein each rod is a U-shaped rod, and the two U-shaped rods have openings opposite to each other in the length direction of the frame and form the annular structure.

3. The extension device of claim 2, wherein the two U-shaped rods are rotatably fit with each other through joints.

4. The extension device of claim 3, wherein the joint comprises:
a first half shell fixed to one of the U-shaped rods, a first groove being defined inside the first half shell;
a second half shell fixed with the other U-shaped rod, the second half shell being rotatably connected to the first half shell and the first half shell and the second half shell being engaged with each other to form an installation chamber, and the second half shell having a second groove therein;
a locking member arranged in the installation chamber and slidable in a rotation axis of the first half shell, the locking member, when sliding in the rotation axis, having a locked state in which the locking member is engaged with the first and second grooves simultaneously, and an unlocked state in which the locking member is disengaged from one of the grooves;
a driving member having a spring structure and acting on the locking member to drive the locking member toward the locked state; and
an unlocking member movably installed in one of the half shells and acting on the locking member to drive the locking member toward the unlocked state.

5. The extension device of claim 4, wherein the locking member has a tooth for engaging with the first groove and the second groove, the tooth has two sides opposite to each other in a circumferential direction of the locking member, and wherein one side of the tooth is a slope for guiding the locking member to disengage from one of the grooves.

6. The extension device of claim 2, wherein each U-shaped rod has a transverse section extending in the width direction and extension sections connected to two ends of the transverse section respectively, and extension sections of the two U-shaped rods corresponding in position are connected to each other, and wherein extension sections of one of the U-shaped rods have bent portions so that the transverse section of said U-shaped rod sinks accordingly.

7. The extension device of claim 6, wherein the two U-shaped rods consist of a first rod and a second rod respectively, and wherein the transverse section of the first rod is provided with an upper convex member, and the bent portions are located on the extension sections of the first rod.

8. The extension device of claim 7, wherein the cart frame is provided with an extension seat, the extension device further comprises an adapter fixed to the frame, and the adapter is configured to be plugged into the extension seat; and
two adapters are provided, which are respectively connected to the extension sections of the second rod, and each adapter is provided with one or more positioning structures.

9. The extension device of claim 8, wherein the transverse section of the second rod is provided with a limiting member, and the limiting member has one or more positioning structures;
the positioning structures on the adapter and the limiting member are configured to detachably connect a seat.

10. The extension device of claim 9, wherein the one or more positioning structures on the limiting member comprises a mating hole, and the mating hole passes through the limiting member and is open to a bottom surface of the limiting member facing away from the first rod.

11. The extension device of claim 8, wherein the adapter comprises:
a base portion fixed to the frame;
a plug portion located outside the base portion, wherein a top of the plug portion is fixedly connected with the base portion, and the plug portion extends downward for being inserted into the extension seat; and
an outer extension portion extending outward from the base portion in the width direction, wherein a top surface of the outer extension portion is provided with a receiving slot as the positioning structure.

12. The extension device of claim 11, wherein a lock hole is defined on an inside of the plug portion and a support member is provided on a bottom of the plug portion.

13. The extension device of claim 12, wherein the bottom of the plug portion has an upward recessed area, the support member is movably arranged in the recessed area, the plug portion has an inner cavity in which a spring member is provided, and one end of the support member is slidably inserted into the inner cavity and abuts against the spring member.

14. The extension device of claim 13, wherein the recessed area is provided with an avoidance hole communicated with the inner cavity, the support member extends into the inner cavity through the avoidance hole, and the support member is rod-shaped and has a radially outward protrusion located in the inner cavity to prevent the support member from falling off from the avoidance hole.

15. The extension device of claim 11, wherein the adapter further comprises:
a plate-shaped portion extending downward from the base portion, wherein a bottom side of the plate-shaped portion has a positioning opening and/or a positioning hole as the positioning structure, and wherein a periphery of the positioning opening is open to the bottom side, and a periphery of the positioning hole is closed.

16. The extension device of claim 15, wherein the plate-shaped portion is located inside the plug portion, and a pocket-shaped portion is provided below the positioning opening, and wherein a top side of the pocket-shaped portion is open, and an interior of the pocket-shaped portion is communicated with the positioning opening.

17. The extension device of claim 1, wherein the frame is further connected with a strap as a positioning structure.

18. A seat system, comprising a seat and an extension device, the extension device comprises:
a frame which generally has an annular structure and consists of two rods, wherein the frame has a length direction and a width direction, each rod has a transverse section extending in the width direction and extension sections connected to two ends of the transverse section respectively, and extension sections of the two rods corresponding in position are connected to each other; and
an adapter fixed to the frame, wherein the adapter has a positioning structure, and the seat is detachably connected to the positioning structure.

19. A cart, comprising a cart frame and a seat system, the seat system comprising a seat and an extension device, the extension device comprises:
a frame detachably connected to the cart frame, wherein the frame generally has an annular structure and consists of two rods, the frame has a length direction and a width direction, each rod has a transverse section extending in the width direction and extension sections connected to two ends of the transverse section respectively, and extension sections of the two rods corresponding in position are connected to each other; and
an adapter fixed to the frame, wherein the adapter has a positioning structure, and the seat is detachably connected to the positioning structure.

20. The cart of claim 19, wherein the cart frame comprises two side frames arranged opposite to each other; and a plurality of support members connected between the two side frames, and wherein each side frame comprises a vertical synchronization rod with a front foot assembly and a rear foot assembly arranged on two sides of the vertical synchronization rod; the front foot assembly comprises a front foot rod with an upper front oscillating rod and a lower front oscillating rod hinged between the vertical synchronization rod and the front foot rod; a bottom of the front foot rod is hinged to a front wheel; the rear foot assembly comprises a rear foot rod with an upper rear oscillating rod and a lower rear oscillating rod hinged between the vertical synchronization rod and the rear foot rod; a bottom of the rear foot rod is hinged to a rear wheel, and wherein
in a folded state, the front foot assembly and the rear foot assembly respectively move towards the vertical synchronization rod; and in a deployed state, the front foot assembly and the rear foot assembly are correspondingly deployed.
